(19) United States
(12) Patent Application Publication
(10) Pub. No.: US 2026/0161712 A1
(43) Pub. Date: Jun. 11, 2026

(54) SYSTEMS AND METHODS FOR UTILIZING MULTIPLE SPECIALIZED GENERATIVE MODELS

(71) Applicant: GOOGLE LLC, Mountain View, CA (US)

(72) Inventors: Deven Tokuno, Bellevue, WA (US); Adam Coimbra, Los Altos, CA (US); Mingjie Liu, Milpitas, CA (US); Cheng Sheng, Cupertino, CA (US); Song Xiong, Sunnyvale, CA (US); Ian Dapot, San Francisco, CA (US); Robert Bettridge, San Mateo, CA (US); Shaun Post, San Mateo, CA (US); John Steidle, San Francisco, CA (US); Vijay Dollu, Short Hills, NJ (US); Gabor Angeli, Cupertino, CA (US); Chinmay Kulkarni, Atlanta, GA (US)

(21) Appl. No.: 19/410,369

(22) Filed: Dec. 5, 2025

Related U.S. Application Data
(60) Provisional application No. 63/729,105, filed on Dec. 6, 2024.

(51) Int. Cl. G06F 16/903; G06F 16/9032; G06F 16/9035; G06F 16/9038

(52) U.S. Cl. CPC G06F 16/90335; G06F 16/9032; G06F 16/9035; G06F 16/9038

(57) ABSTRACT

Implementations are directed to receiving a request and identifying corresponding descriptive data assigned to each of multiple specialized generative models (SGMs) that are available for invocation in processing the request. A prompt is generated, that includes the request and the corresponding descriptive data, and processed using a generative model to generate initial content. Based on the initial content, a subset of the multiple SGMs is determined for use in processing the request. For example, the subset can include multiple SGMs. Corresponding specialized content is generated based on processing the request utilizing each of the SGMs of the subset, and responsive content for the request is generated based on the corresponding specialized contents generated utilizing the SGMs. Processing the request, utilizing a SGM, can include processing the request in its entirety or processing a specialized request that is derived from the request, such as one reflected in the initial content.

### BACKGROUND

Generative models, such as large language models (LLMs), visual language models (VLMs), image generation models, and multimodal (multimodal input and/or multimodal output) models have been utilized for various purposes. Moreover, specialized generative models have been proposed for use for various purposes. A specialized generative model, as used herein, can be one that is always utilized in conjunction with a prompt that includes certain instructions, one that utilizes certain corpus(es) via which to retrieve content for including in a prompt (e.g., by way of retrieval augmented generation (RAG)), one that utilizes certain external tool(s) to generate tool content for including as part of the prompt, and/or one that is fine-tuned (e.g., via supervised fine-tuning (SFT), reinforcement learning with human feedback (RLHF), and/or other technique(s).

For example, a user can cause generation of a specialized generative model by specifying certain instructions that are to be utilized in conjunction with prompts that are processed utilizing a generative model. While the generative model itself need not be unique/specialized (e.g., the same underlying model with the same trained weights can be used for multiple specialized generative models), it can be a specialized generative model by way of the user having specified the certain instructions that are to be included in prompts that are to be processed utilizing the generative model. For example, a user can cause generation of a “conciseness” specialized generative model by specifying instructions of “rewrite my input to reduce its length by about fifty percent, while ensuring that the rewritten input maintains substantially all of the information included in that of its corresponding input”. The user, or another user if the specialized generative model is shared, can thereafter invoke the “conciseness” specialized generative model by, for example, explicitly selecting an indication of it via a graphical user interface (GUI) or via including an alias of it (e.g., an alias of “@conciseness”) as part of an input field in a GUI. When the “conciseness” specialized generative model is invoked, it can be used in processing user specified input provided in conjunction with the invocation. For example, the user specified input can include a long paragraph of text from a draft email and it can be processed, using the “conciseness” specialized generative model, by processing, using a generative model, a prompt of the form “rewrite my input to reduce its length by about fifty percent, while ensuring that the rewritten input maintains substantially all of the information included in that of its corresponding input; my input=(long paragraph of text from a draft email)”.

As another example, a user can cause generation of a specialized generative model by additionally or alternatively specifying input corpus(es) to be utilized for at least selectively retrieving content for inclusion in a prompt utilizing a generative model. For example, a user can cause generation of a “patents” specialized generative model by specifying that only a patent corpus, including published patents and patent applications, should be utilized in retrieving RAG content for inclusion in a prompt. The user, or another user if the specialized generative model is shared, can thereafter invoke the “patents” specialized generative model by, for example, explicitly selecting an indication of it via a GUI or via including an alias of it (e.g., an alias of “@patents”) as part of an input field in a GUI. When the “patents” specialized generative model is invoked, it can be used in processing user specified input provided in conjunction with the invocation. For example, the user specified input can include “provide a summary of uses for attention-based neural networks in 2019” and invocation of the “patents” specialized generative model can cause retrieval, from the patent corpus, of content that is relevant to the user specified input (e.g., snippets from patent documents filed in 2019 and directed toward attention-based neural networks). A prompt, that includes the user specified input and the retrieved content, can then be processed utilizing a generative model to generate responsive content, and such responsive content provided in response to the user specified input.

As yet another example, a developer can cause generation of a specialized generative model by fine-tuning a generative model, thereby creating a fine-tuned specialized generative model that has different weights than the generative model. The developer can share the fine-tuned specialized generative model with other users, thereby enabling the other users to explicitly invoke the fine-tuned specialized generative model for utilization in processing user specified input.

Specialized generative models can provide various advantages. For example, they enable various user specified inputs to be processed in a particular desired manner, without requiring the user to explicitly specify that particular desired manner with each of the various user specified inputs. Rather, the particular desired manner can be set-up once (e.g., via specifying of certain instructions, specifying certain corpus(es), and/or fine-tuning) through generation of a specialized generative model by a user or another user, and thereafter utilized by the user via explicit invocation of the specialized generative model (e.g., selection of or specifying of an alias thereof). In these and other manners, specialized generative models can reduce a quantity of user inputs needed for causing input to be processed in a certain manner.

However, current utilization of specialized generative models presents various drawbacks. For example, when multiple specialized generative models are available to be invoked, it can require a large quantity of inputs or otherwise be burdensome to manually specify, in a GUI, which particular specialized generative model is to be invoked. For example, when the GUI is rendered via a mobile device or other computing device with relatively limited display/input surface area, it can be impossible to simultaneously render aliases and/or descriptors of all available specialized generative models. This can cause a user to have to scroll and/or navigate through a GUI to identify which specialized generative model should be invoked for an input. As another example, for voice-only modalities (e.g., when the computing device lacks any display or includes a display but is being utilized in a voice-only modality), visual rendering of indications of specialized generative models is not possible and, further, audible rendering of such indications can be computationally burdensome and/or prolong a human-computer interaction. As yet another example, as the quantity of available specialized generative models continues to grow (e.g., to thousands of specialized generative models), even GUIs presented on a large display can be unable to simultaneously render even a small subset of such specialized generative models. This can lead to under-utilization of such specialized generative models, preventing benefits thereof from being achieved and resulting in prolonged human-computer interactions. As yet a further example, current utilization of specialized generative models can present difficulties with (or even not enable) utilization of multiple specialized generative models, in combination, in processing a user specified input. For example, if multiple specialized generative models are to be utilized in processing a particular singly user specified input, the aforementioned drawbacks of invoking a single specialized generative model are exacerbated.

### SUMMARY

Implementations disclosed herein are directed to receiving a request, that is generated based on user interface input at a client device, and identifying corresponding descriptive data assigned to each of multiple specialized generative models that are available for invocation in processing the request. A prompt is generated that includes the request and the corresponding descriptive data, and this prompt is processed using a generative model, that is separate from the specialized generative models, to generate initial content. Based on the initial content, a subset of the multiple specialized generative models is determined for use in processing the request. For example, the subset can include two or more of the specialized generative models. Corresponding specialized content is generated based on processing the request utilizing each of the specialized generative models of the subset, and responsive content for the request is generated based on the corresponding specialized contents generated utilizing the specialized generative models. Processing the request, utilizing a specialized generative model of the subset, can include processing the request in its entirety or processing a specialized request that is derived from the request, such as a specialized request reflected in the initial content. Output, that is based on the responsive content, is then rendered at the client device responsive to the request.

In various implementations, the initial content can indicate each of the specialized generative models of the subset and, for each of the specialized generative models, a corresponding specialized request that is based on, but can differ from the request. The corresponding requests can then be processed utilizing the specialized generative models of the subset to generate the corresponding specialized content. For example, a first specialized request of the initial content can be processed utilizing a first specialized generative model of the subset to generate first specialized content, a second specialized request of the initial content can be processed utilizing a second specialized generative model of the subset to generate second specialized content, etc. In some of these implementations, a comprehensive response prompt that includes the corresponding specialized content from each of the specialized generative models of the subset can be generated and the comprehensive response prompt can then be processed, using the generative model, or an additional generative model, to generate the responsive content for the request. For example, the comprehensive response prompt can be of the form “generate a comprehensive response to (request) that conveys all of the information of the following content, while avoiding duplicating any information: (specialized content 1), . . . (specialized content N)”.

Implementations disclosed herein can mitigate (e.g., lessen or eliminate) various drawbacks with current techniques for utilizing specialized generative models. For example, by automatically determining a subset of specialized generative models to utilize, based on the initial content generated from a prompt including the user request and descriptive data assigned to each specialized generative model, the need for manual selection of multiple models is reduced or eliminated. This can eliminate the burden of manually specifying models in a GUI, particularly on devices with limited display/input area or in voice-only modalities. As another example, this automated selection process allows for the seamless combination of multiple specialized generative models, addressing the difficulty of utilizing multiple specialized generative models simultaneously and ensuring that multiple specialized generative models are utilized in combination when appropriate. As yet another example, the system can handle a large number of available specialized generative models, overcoming the limitations of GUIs in simultaneously rendering available specialized generative models.

In various implementations, the descriptive data that is assigned to a given specialized generative model can be based on creator-provided descriptive data that is based on descriptions provided by a creator of the given specialized generative model. In various implementations, the descriptive data that is assigned to the specialized generative model can additionally or alternatively can be generated based on historical interaction data that reflects historical interactions of one or more users with the given specialized generative model. In these and other manners, the descriptive data can reflect not only how the creator described the given specialized generative model, but how user(s) have actually interacted with the given specialized generative model. This can result in more accurate and/or robust selection of the given specialized generative model, as the historical interaction data can reflect usage(s) of the given specialized generative model that were not contemplated by the creator and/or can refine inaccurate (or even misleading) creator-provided descriptive data.

As a particular example, the descriptive data assigned to a given specialized generative model can be based on historical interactions of one or more users that can include, or be restricted to, a user that provided the user interface input. For example, the historical interaction data can include prior requests, by the user that provided the user interface input, from instances where the given specialized generative model was explicitly invoked based on user input of the user. For instance, instances where the user explicitly invoked the specialized generative model by including its alias, optionally preceded by an “@” mention or other delimiter, as part of the prior requests and/or instances where the user explicitly selected, as part of the prior requests, one or more graphical interface elements (e.g., buttons) that described the specialized generative model and that, when selected, invoke the specialized generative model for use in processing the user request. In generating the descriptive data based on such prior requests, a descriptive data prompt, that includes the prior requests and optionally other data, can be processed, using the generative model or an additional generative model, to generate the descriptive data. For example, the descriptive data prompt can be of the form “generate a 1 to 3 sentence summary that describes features present in one or more of the following requests, emphasizing features that are common among multiple of the request: (prior request 1), . . . (prior request N)”.

In implementations where the historical interaction data is restricted to a user that provided the user interface input, the descriptive data that is generated based on the user-specific historical interaction data can be utilized in generating the prompt based on determining that the user interface input is from the user. For example, the user interface input can be determined as being from the user based on an account of the user being active when the user interface input is provided and/or based on voice and/or facial recognition. Put another way, the descriptive data that is user-specific is utilized based on the user having provided the user interface input, thereby ensuring that the initial content (generated based on the prompt that includes the descriptive data) on which the subset of specialized generative models is determined accurately reflects specialized generative model(s) that are useful to the particular user that provided the user interface input. For example, assume a given specialized generative model that includes given instructions for reducing the length of input while maintaining key information from the input. Further assume that User A explicitly invokes the given specialized generative model on multiple occasions for utilization in shortening corresponding descriptions of rental properties whereas User B explicitly invokes the given specialized generative model on multiple occasions for utilization in shortening corresponding descriptions of cats in need of adoption. In such an example, the descriptive data for User A can reflect utilization with description of rental properties but not reflect any utilization with description of cats in need of adoption, whereas the descriptive data for User B can reflect utilization with description of cats in need of adoption but not reflect any utilization with description of rental properties.

In some implementations, the subset of the multiple specialized generative models that are determined, based on the initial output, for use in processing the request, are used in processing the request without first prompting the user. For example, the subset can be utilized to generate corresponding specialized contents without first providing any indication of the subset to the user. In some of those implementations, an indication of the subset that was utilized can be caused to be rendered at the client device and along with the output. For example, alias(es) and/or description(s) (e.g., creator-provided) of the utilized specialized generative model(s) can be graphically rendered above, below, or beside a graphical rendering of the output and/or alias(es) and/or description(s) of the utilized specialized generative model(s) can be audibly rendered before or following audible rendering of the output.

In some other implementations, the user is first prompted with a user prompt that specifies the subset, and processing using the subset only performed responsive to affirmative user interface input being received in response to the user prompt. For example, alias(es) and/or description(s) of the subset of specialized generative model(s), determined based on the initial input, can be caused to be rendered to the user and processing the request utilizing such subset can be contingent on receiving an affirmative user input in response to the rendering. An affirmative user input can be, for example, a selection of an interface element such as an “okay” or “yes” button, a verbal affirmative input such as “yes” or “yes”, a certain touch gesture, passage of a threshold length of time following presentation of the user prompt and without receipt of any negative user input, and/or other affirmative indication. In some of those other implementations, the user prompt can be provided before the user has indicated a completion of the request, such as before the user has pressed enter, clicked a submit button, or otherwise indicated completion.

As a non-limiting example of implementations disclosed herein, assume a user enters the request “find an early 2000's software patent and write some code based on its teachings”. Implementations can initially identify several (e.g., tens, hundreds, thousands), of specialized generative models that can be utilized in processing this request. A prompt that includes the request “find an early 2000's patent about temperature control and write some code based on its teachings”, along with descriptive data assigned to each of the identified specialized generative model is then generated. The specialized generative models can include a first specialized generative model that is restricted to searching a patent corpus, a second specialized generative model that is fine-tuned for utilization in processing natural language content to generate corresponding Python code, and multiple additional specialized generative models. The descriptive data assigned to the first specialized generative model can include creator-provided descriptive data describing that it is a model that is restricted to searching a patent corpus and the descriptive data assigned to the second specialized generative model can include user-specific descriptive data describing its use, in prior explicit invocations by the user, in generating code for control systems.

The prompt is then processed using a generative model to generate initial content that indicates the first specialized generative model and a first specialized request, for the first specialized generative model, of “temperature control; date range: Jan. 1, 2000-Dec. 31, 2005” and that indicates the second specialized generative model and a second specialized request, for the second specialized generative model, of “generate code that performs the function(s) of claim 1 from [top patent document from first specialized generative model]”. The first specialized request can then be processed utilizing the first specialized generative model to generate corresponding first specialized content that includes patent(s) from the early 2000's and that are directed to temperature control. The second specialized request, with claim 1 from the top patent document from the first specialized content, can then be processed utilizing the second specialized generative model to generate corresponding second specialized content that includes Python code that can be executed to perform the function(s) of claim 1 from the top patent document of the first specialized content. Output, that is based on the generated Python code, can be caused to be rendered responsive to the request.

Continuing with the same non-limiting example, assume a different user enters the same request. However, the descriptive data assigned to the second specialized generative model does not include any user-specific descriptive data for the second user (e.g., due to the second user having not explicitly invoked the second specialized generative model), but a third specialized generative model, that is fine-tuned for utilization in processing natural language content to generate corresponding Fortran code, includes user-specific descriptive data describing its use, in prior explicit invocations by the second user, in generating code for control systems. For the second user for the same request, the initial content can indicate utilization of the third specialized generative model in lieu of utilization of the second specialized generative model, thereby resulting in generation of Fortran code in lieu of Python code, and provision of output that is based on the Fortran code.

As another non-limiting example of implementations disclosed herein, assume a user enters a request that includes an image of a circuit diagram and natural language content of “provide a concise summary of the function of this circuit diagram and a description of the circuit diagram as it would be described in a patent application”. Implementations can initially identify several (e.g., tens, hundreds, thousands), of specialized generative models that can be utilized in processing this request. A prompt that includes the image of the circuit diagram and the natural language content, along with descriptive data assigned to each of the identified specialized generative model is then generated. The specialized generative models can include a first specialized generative model that includes specialized instructions for generating concise summaries of an image and a second specialized generative model that includes specialized instructions for generating multiple detailed explanations of an image that contemplate all possible ways the image can be interpreted. The descriptive data assigned to the first specialized generative model can include creator-provided descriptive data describing that it generates concise summaries of images. The descriptive data assigned to the second specialized generative model can include creator-provided descriptive data describing only that it is able to come up with all of the possible explanations of an image. The descriptive data assigned to the second specialized generative model can additionally include descriptive data, generated based on historical interaction data of multiple users, that reflects that the second specialized generative model was used (perhaps unexpectedly by the creator) in generating image descriptions for utilization in patent applications.

The prompt is then processed using a generative model to generate initial content that indicates the first specialized generative model, a first specialized request for the first specialized generative model, the second specialized generative model, and a second specialized request for the second specialized generative model. The first specialized request can then be processed utilizing the first specialized generative model to generate corresponding first specialized content, and the second specialized request can then be processed utilizing the second specialized generative model to generate corresponding second specialized content. Output, that is based on the generated first specialized content and based on the generated second specialized content, can be caused to be rendered responsive to the request. Notably, in this example, the second specialized generative model can be indicated in the initial content based on being associated with historical interaction data that indicates that it was utilized, perhaps unexpectedly, by multiple users for utilization in generating image descriptions for utilization in patent applications. Absent such descriptive data that is based on historical interaction data, the initial content might have lacked any indication of the second specialized generative model.

As yet another non-limiting example of implementations disclosed herein, consider a user enters the request “Plan a surprise 30th birthday party for John, who loves Star Wars and BBQ, in San Francisco on October 28th.” Implementations can initially identify several (e.g., tens, hundreds, thousands) of specialized generative models and associated descriptive data for each, such as: a “Party Planner” specialized generative model (with descriptive data describing its ability to suggest venues, activities, and guest lists), a “Budget Tracker” specialized generative model (with descriptive data describing its capacity to estimate costs and manage budgets), a “Theme Generator” specialized generative model (with descriptive data describing its ability to create themed party plans), and a “San Francisco Venue Finder” specialized generative model (with descriptive data describing its functionality to locate suitable venues in San Francisco). An initial prompt, incorporating the user request and the specialized generative models' descriptive data, is processed by a generative model, that can be distinct from any of the specialized generative models, to generate initial content. The initial content can indicate a subset of the specialized generative models that are to be utilized in processing the request, such as the “Party Planner,” “Budget Tracker,” and “San Francisco Venue Finder” models. These specialized generative models are then invoked (e.g., in parallel or in sequence), generating corresponding specialized content: the “Party Planner” suggests a venue and activities, the “Budget Tracker” provides a cost estimate, and the “San Francisco Venue Finder” locates venues matching the criteria. Finally, the system synthesizes this specialized content into a comprehensive party plan, including venue options, activity suggestions, budget breakdown, and a potential guest list, presented to the user as a unified response.

In various implementations disclosed herein a request that is received can lack any explicit indication of any specialized generative models. Nonetheless, techniques disclosed herein can be utilized to determine a subset of specialized generative models to utilize in processing the request.

In some other implementations, a request can be received that includes an explicit indication of multiple generative models. For example, the request can include markdowns that identify aliases of multiple specialized generative models, such as multiple “@” markdowns that are each followed by an alias of a corresponding specialized generative models. For instance, the request can be “find an early 2000's software patent and write some code based on its teachings @patentsearcher @pythongenerator”. In some of those other implementations, in response to receiving the request corresponding descriptive data can be identified that is assigned to each of the multiple specialized generative models that are explicitly indicated in the request. Further, a prompt can be generated that includes at least part of the request (e.g., the non explicit invocation portion thereof such as “find an early 2000's software patent and write some code based on its teachings”) and the corresponding descriptive data, and this prompt processed using a generative model, that is separate from the specialized generative models, to generate initial content. The initial content can reflect a corresponding specialized request for each of the specialized generative models that are explicitly indicated in the request. Each of the specialized requests can then be processed, using a corresponding specialized generative model, to generate corresponding specialized content. Responsive content can then be generated based on the specialized contents and output, that is based on the responsive content, then caused to be rendered at the client device responsive to the request. In these and other manners, although the request explicitly indicates specialized generative model(s) to be utilized, techniques disclosed herein can still utilize descriptive data for those specialized generative models in determining specialized requests to process, using the specialized generative models, in generating corresponding specialized content.

The preceding is provided as an overview of only some implementations disclosed herein. Those and other implementations are described in additional detail herein.

Some implementations can include a system that includes one or more processors and memory storing instructions that, when executed by the one or more processors (e.g., central processing unit(s), tensor processing unit(s) TPU(s), graphics processing unit(s) GPU(s), and/or other processors), cause the one or more processors to perform a method such as one of those described herein. Some implementations can additionally or alternatively include one or more transitory or non-transitory computer readable storage media storing computer instructions executable by one or more processors to perform a method such as one of those described herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an example of how components of FIG. 1 can interact in processing a request utilizing multiple specialized generative models, in accordance with various implementations.

FIG. 3 depicts a flowchart illustrating an example method for utilizing multiple specialized generative models in processing a request, in accordance with various implementations.

FIG. 4 depicts a flowchart illustrating an example method for determining and storing descriptive data for a specialized generative model, in accordance with various implementations.

FIG. 5A depicts an example of a graphical user interface in which multiple specialized generative models can be invoked.

FIG. 5B depicts another example of a graphical user interface in which multiple specialized generative models can be invoked.

FIG. 6 illustrates an example architecture of a computing device.

### DETAILED DESCRIPTION

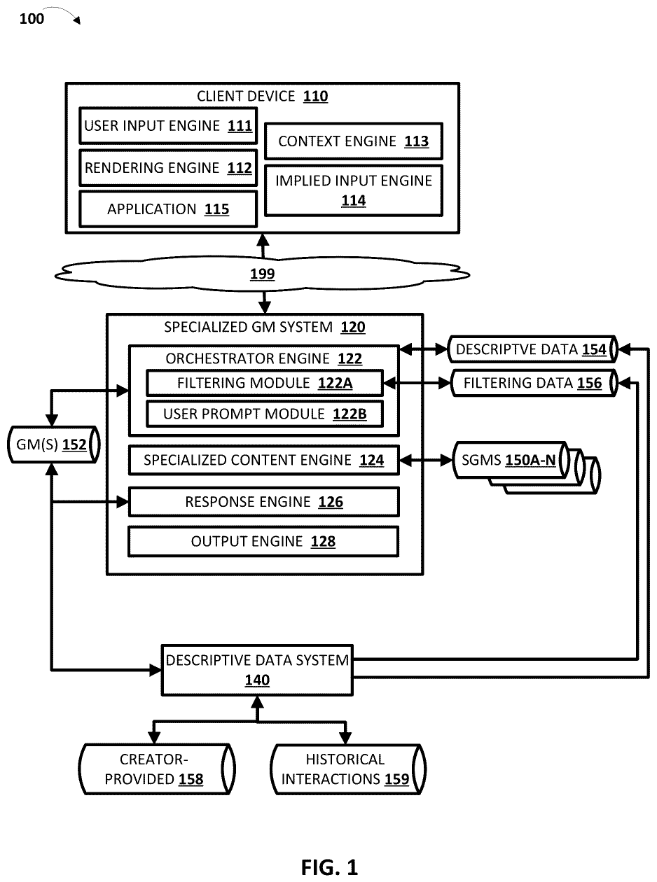

FIG. 1 depicts a block diagram of an example environment 100 that demonstrates various aspects of the present disclosure, and in which implementations disclosed herein can be implemented. The example environment 100 includes a client device 110, a specialized generative model (GM) system 120, and a descriptive data system 140. The example environment 100 also includes generative model(s) (GM(s)) 152 that are utilized by specialized GM system 120, descriptive data system 140, and/or other component(s). The example environment 100 further includes multiple specialized generative models (SGMs) 150A-N, one or more of which are selectively utilized by the specialized GM system 120 in processing a request. The SGMs 150A-N can include, tens, hundreds, or thousands of SGMs, including user-specific SGM(s) that are created by a respective user and accessible only to the respective user and/or shared SGM(s) that are each created by a respective user or a respective entity and that are accessible to multiple users (e.g., publicly available to all users). The SGMs 150A-N can include various different types of SGMs such as SGM(s) that include certain instructions that are to be utilized in conjunction with prompts that are processed utilizing the SGM, SGM(s) that include a certain corpus that is utilized to retrieve content for including in prompts that are to be processed utilizing the SGM, SGM(s) that include certain instructions to be utilized in conjunction with prompts and that include a certain corpus that is utilized to retrieve content for including in prompts, and/or SGM(s) that are fine-tuned variations of a generative model.

Although illustrated separately, in some implementations all or aspects of specialized GM system 120, descriptive data system 140, and/or SGMs 150A-N can be implemented as part of a cohesive system. For example, the same entity can be in control of the specialized GM system 120, the descriptive data system 140, and the SGMs 150A-N—and implement them cohesively. However, in some implementations the specialized GM system 120, the SGM(s), and/or the descriptive data system 140 can be controlled by separate parties. For example, one or more of the SGMs 150A-N can be implemented by a party that is separate from a party that implements the specialized GM system 120 and the specialized GM system 120 can interface with such SGMs 150A-N utilizing, for example, application programming interface(s) (APIs).

In some implementations, all or aspects of the specialized GM system 120 can be implemented locally at the client device 110. In additional or alternative implementations, all or aspects of the specialized GM system 120 can be implemented remotely from the client device 110 as depicted in FIG. 1 (e.g., at remote server(s)). In those implementations, the client device 110 and the specialized GM system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which requests can be submitted and/or via which generative output(s) that include generative response(s) generated by generative model(s) and/or other response(s) to the requests can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the specialized GM system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein, that can be included in a request, can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, an image query that is based on an image captured by a vision component of the client device, and/or a multimodal query such as one that includes an image and a typed query or one that includes audio data that captures a spoken voice query and that includes a predicted transcription of the spoken voice query.

In various implementations, the client device 110 can include a rendering engine 112 that is configured to provide a generative response (e.g., a natural language based response generated by an LLM) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, as all or part of dialog context described herein. A context determined by the context engine 113 can additionally or alternatively be utilized, for example, in supplementing or rewriting a query that is formulated based on user input, in generating an implied query (e.g., a query formulated independent of user input), and/or in determining to submit an implied query and/or to render result(s) (e.g., an LLM generated response) for an implied query.

In various implementations, the client device 110 can include an implied input engine 114 that is configured to: generate an implied query independent of any user input directed to formulating the implied query; to submit a request that includes the implied query, optionally independent of any user input that requests submission of the request; and/or to cause rendering of a response for an implied query, optionally independent of any user input that requests rendering of the response. For example, the implied input engine 114 can use current context, such as current location and/or current query, from current context engine 113, in generating an implied query, determining to submit a request that includes the implied query, and/or in determining to cause rendering of a response for the implied query. For instance, the implied input engine 114 can automatically generate and automatically submit an implied query based on the current context. Further, the implied input engine 114 can automatically push a response to the implied query to cause the response to be automatically rendered or can automatically push a notification of the response, such as a selectable notification that, when selected, causes rendering of the response. As another example, the implied input engine 114 can generate an implied query based on profile data (e.g., an implied query related to an interest of a user), submit the query at regular or non-regular intervals, and cause a corresponding response to be automatically provided (or a notification thereof automatically provided).

Further, the client device 110, the specialized GM system 120, and/or the descriptive data system 140 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device 110 having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

Specialized GM System 120 is illustrated as including an orchestrator engine 122 with a filtering module 122A and a user prompt module 122B, a specialized content engine 124, a response engine 126, and an output engine 128. Some of the engines can be omitted in various implementations.

In response to receiving a request from the client device 110, the orchestrator engine 122 can select, from a superset of SGMs 150A-N, a subset of SGMs 150 (e.g., one or more), of the superset, to utilize in processing the request. The specialized content engine 124 can then utilize each of the selected SGMs of the subset in processing the request to generate corresponding specialized content from each of the selected SGMs. The response engine 126 can then generate responsive content for the request, based on the specialized content, and the output engine 128 can cause the responsive content to be rendered (audibly and/or visually) in response to the request via the client device 110.

In selecting a subset of SGMs 150 to utilize in processing the request, the orchestrator engine 122 can utilize descriptive data database 154 that includes, for each of the SGMs 150A-N, descriptive data that describes functionality of the SGM. For example, the orchestrator engine can generate a prompt that includes the request and the descriptive data for all of, or an initial subset of, the SGMs 150A-N. The orchestrator engine 122 can then process the prompt using a generative model, of GM(s) 152, to generate initial content. For example, the prompt can be of the form “for the request [request] and given the following specialized generative models and their descriptions, indicate which specialized generative model(s) to utilize in processing the request, and what specialized request should be utilized by each, where each specialized request specifies the request that is to be made to each and can optionally include content that is contingent on output from one or mor other specialized generative models; [supervised generative models and their descriptions]”.

Based on the initial content, the orchestrator engine 122 can determine the subset of the SGMs 150A-N to utilize for processing the request. For example, the orchestrator engine 122 can select those SGMs 150A-N that are reflected in the initial content and exclude those SGMs 150A-N that are not reflected in the initial content. Further, the orchestrator engine 122 can determine, based on the initial content, a corresponding specialized request for each of the SGMs 150A-N of the subset.

In implementations where the filtering module 122A is utilized, it can be utilized to select the initial subset, of the superset of SGMs 150A-N, that are included in the prompt. In some of those implementations, the filtering module 122A can utilize filtering data 156, that is different from the descriptive data 154, to select the initial subset of SGMs 150A-N. For example, the filtering data 156 for an SGM can include data that indicates a popularity of the SGM (globally or for the user that submitted the request), whether the SGM has been previously explicitly invoked by the user, modality(ies) of input that are compatible with the SGM, whether the SGM was created by the user, and/or other data that is specific to the SGM. The filtering module 122A can utilize such filtering data 156 to determine whether to select the SGM for inclusion in the initial subset. For example, the filtering module 122A can determine to exclude an SGM from inclusion in the initial subset if the SGM modality(ies) of input are not compatible with the request (e.g., the request includes an image and the SGM modality(ies) do not include an image modality). As another example, the filtering module 122A can determine to always include, in the initial subset, any SGM(s) created by the user and/or previously explicitly invoked by the user. As yet another example, the filtering module 122A can determine to exclude an SGM from inclusion in the initial subset based on the SGM having a popularity and/or other measure that fails to satisfy a threshold. In some implementations, the extent of filtering by the filtering module 122A can be dependent on an available context window for the GM, of GM(s) 152, that is to be utilized in processing the prompt, which can depend on the request.

In some implementations, where the user prompt module 122B is utilized, it can be utilized to generate a user prompt that includes alias(es) and/or at least some of the descriptive data for one or more of the SGMs 150A-N of the subset selected based on the initial content (e.g., that are each represented in the initial content). The user prompt can further request, explicitly or implicitly, the user to verify whether the user acquiesces to utilizing the SGMs 150A-N of the subset. The output engine 128 can then transmit the user prompt to the client device 110, which can render the user prompt. In response to receiving affirmative user input responsive to the prompt, the specialized content engine 124 can utilize each of the SGMs 150A-N of the subset in processing the request to generate corresponding specialized content from each of the SGMs 150A-N. If no affirmative user input is received, or if negative user input is received, processing of the request can proceed without utilizing any of the SGMs 150A-N or, alternatively, an alternative prompt can be generated by the orchestrator engine 122 to determine an alternative subset of the SGMs 150A-N to utilize in processing the request. Such an alternative subset can optionally be constrained based on the SGMs 150A-N in the previous subset and, further, the user prompt module 122B can be utilized to generate another user prompt that includes alias(es) and/or at least some of the descriptive data for one or more of the SGMs of the alternative subset (e.g., that are each represented in the alternative subset).

The specialized content engine 124 can utilize each of the selected SGMs of the subset in processing the request to generate corresponding specialized content from each of the selected SGMs. For example, the specialized content engine 124 can, for each of the selected SGMs of the subset, cause a specialized request (e.g., indicated by orchestrator engine 122 based on the initial content) to be processed by the SGM and specialized content can be generated based on results of that processing.

The response engine 126 can then generate responsive content for the request, based on the specialized content generated from each of the selected SGMs. For example, the response engine 126 can generate the responsive content by composing a response based on some or all of the specialized contents from the subset of selected SGMs. For instance, the response engine 126 can generate a comprehensive response prompt, that includes some or all of the specialized content generated from each of the SGMs 150A-N of the subset, and process the comprehensive response prompt using a generative model, of GM(s) 152, to generate the responsive content.

The output engine 128 can then cause the responsive content to be rendered via the client device 110 in response to the request. For example, the output engine 128 can cause the responsive content to be audibly rendered via one or more speakers of the client device 110 and/or visually rendered via a display of the client device 110.

The descriptive data system 140 can generate, store, and/or otherwise maintain descriptive data database 142, that includes, for each SGM 150 of the SGMs 150A-N, corresponding descriptive data that describes functionality of the SGM 150. The descriptive data system 140 can additionally or alternatively maintain filtering data 156 for the SGMs 150A-N.

In some implementations and/or for some SGMs 150A-N, the descriptive data system 140 can create the descriptive data therefore based on creator-provided descriptions 158 provided by creators of the SGMs 150A-N themselves. For example, a creator of an SGM can provide, in conjunction with creating the SGM, a natural language description of the SGM that can differ from any certain instructions to be utilized in conjunction with the SGM. In some of those implementations, the descriptive data system 140 can generate the descriptive data for the SGM, that is stored in descriptive data database 154 in association with the SGM, based on the creator-provided natural language description. For example, the descriptive data system 140 can utilize, verbatim, the creator-provided description as part of the descriptive data for the SGM. As another example, the descriptive data system can generate a description prompt that includes the creator-provided description and instructions to generate a refined version of that description (e.g., instructions to make it X length and/or in Y tone), process the description prompt using one of the GM(s) 152, and utilize corresponding output as part of the descriptive data.

In some implementations and/or for some SGMs 150A-N, the descriptive data 158 can additionally or alternatively be generated based on one or more historical interactions 153 of one or more users with the SGM. For example, the historical interactions 153 can include prior request(s) and, optionally, prior responses where the prior request(s) are from one or more earlier instances where the SGM was explicitly invoked by a corresponding user. The descriptive data system 140 can process such prior request(s), and optionally corresponding response(s), using one of the GM(s) 152 and utilize corresponding output as part of the descriptive data. For example, the descriptive data system 140 can generate a descriptive data prompt that includes the prior request(s) and, optionally, the response(s) along with instructions to generate a concise summary of features, of the SGM, that can be derived from the prior request(s) and, optionally, the response(s). For instance, the prompt can be of the form “given the following response and request pairs where a specialized generative model was explicitly invoked by the user, generate a distilled description of the function of the specialized generative model: [response, request pairs]”. In some of those implementations, the descriptive data system 140 can further include the creator-provided description in such a prompt. For instance, the prompt can be of the form “given the following response and request pairs where a specialized generative model was explicitly invoked by the user, and given [creator-provided description] of the specialized generative model, generate a distilled description of any function(s) of the specialized generative model that are missing from the creator-provided description: [response, request pairs]”. The descriptive data system 140 can further process such a prompt using one of the GM(s) 152 and utilize corresponding output as part of the descriptive data associated with the SGM.

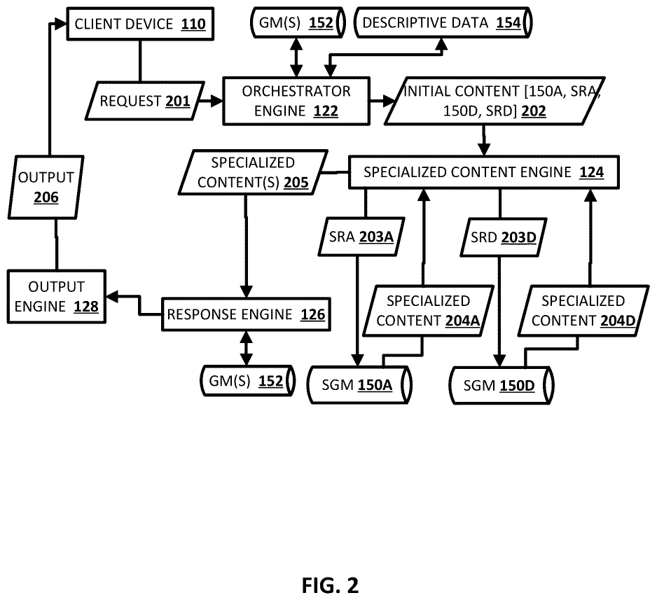

Turning now to FIG. 2, an example of how components of FIG. 1 can interact in processing a request 201 utilizing multiple specialized generative models is described. In FIG. 2, the orchestrator engine 122 receives the request 201 from the client device 110. The orchestrator engine 122 generates a prompt based on the request 201 and descriptive data 154 associated with each of the SGMs 150A-N. The orchestrator engine 122 then processes the prompt using one of the GM(s) 152 to generate initial content 202. The initial content 202 reflects a first SGM 150A, a first specialized request (SRA) for the first SGM 150A, a second SGM 150D, and a second specialized request (SRD) for the second SGM 150D.

The orchestrator engine 122 provides, to the specialized content engine 124 and based on the initial content 202, an indication of (i) the first SGM 150A and the first specialized request (SRA) and (ii) the second SGM 150B. The specialized content engine 124 then utilizes the first SGM 150A in processing the first specialized request (SRA) 203A to generate first specialized content 204A and utilizes the second SGM 150D in processing the second specialized request (SRD) 203D to generate second specialized content 204D. The specialized content engine 124 then provides, to the response engine 126, specialized content(s) 205 that are based on some or all of the first specialized content 204A and/or the second specialized content 204D. The response engine 126 then processes the specialized content(s) 205 using a generative model of the GM(s) 152 to generate responsive content 206 that is responsive to the request 201. The output engine 128 then causes output, that is based on (e.g., conforms to) the responsive content 206, to be rendered at the client device 110.

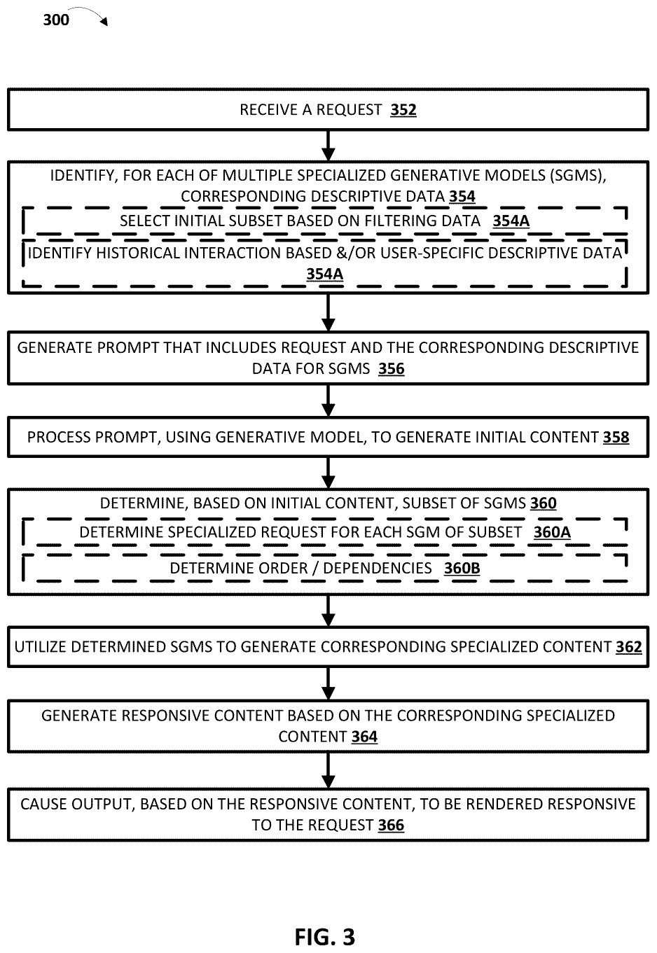

Turning now to FIG. 3, a flowchart illustrating an example method 300 of utilizing multiple specialized generative models in processing a request is depicted. For convenience, the operations of the method 300 are described with reference to a system that performs the operations. This system may include various components of various computer systems, such as one or more components of the specialized GM system 120. Moreover, while operations of the method 300 are shown in a particular order, this is not meant to be limiting. One or more operations may be reordered, omitted or added.

At block 352, the system receives a request from a client device. For example, the request can be received from the client device 110 by the orchestrator engine 122 of the specialized GM system 120.

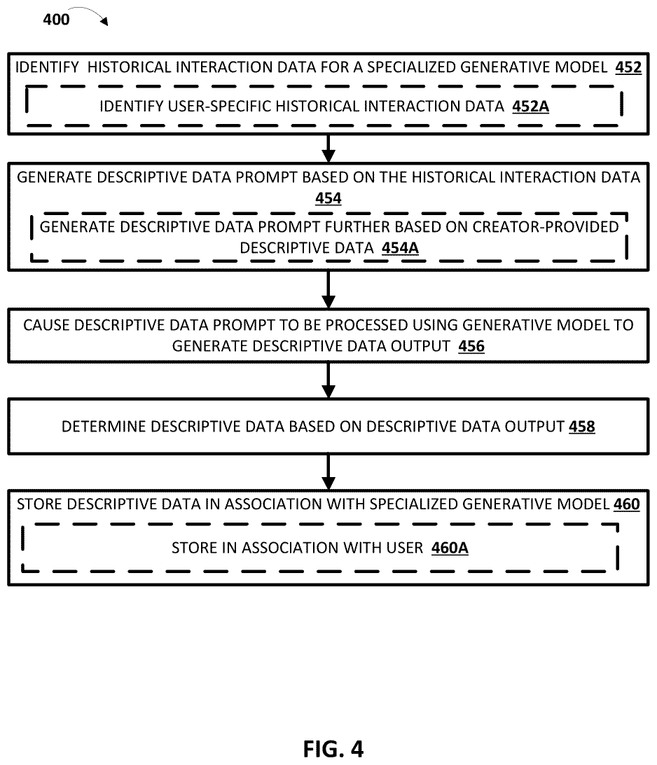

At block 354, the system identifies, for each of multiple specialized generative models, corresponding descriptive data that is assigned to the specialized generative model and that describes functionality of the specialized generative model. For example, the specialized GM system 120 can access a database that includes, for each of the multiple specialized generative models (e.g., the SGMs 150A-N), corresponding descriptive data that is assigned to the specialized generative model and that describes functionality of the specialized generative model. In some implementations, block 354 can include sub-block 354A and/or sub-block 354B. In some implementations, the descriptive data can include descriptive data generated according to method 400 of FIG. 4.

At sub-block 354A, the system selects an initial subset of the multiple specialized generative models based on filter data that is different from descriptive data assigned to each of the multiple generative models. At sub-block 354B, the system determines historical interaction based and/or user-specific based descriptive data for one or more of the specialized generative models.

At block 356, the system generates a prompt that includes the request and the corresponding descriptive data, for the SGMs, identified at block 354. For example, the prompt can be of the form “for the request [request] and given the following specialized generative models and their descriptions, indicate which specialized generative models to utilize in processing the request, and what specialized request should be utilized by each, where each specialized request specifies the request that is to be made to each and can optionally include content that is contingent on output from one or more other specialized generative models.”

At block 358, the system processes the prompt using a generative model, of multiple generative models, to generate initial content. For example, the initial content can indicate, directly or indirectly, each of the specialized generative models that are to be utilized in processing the request and, optionally, a corresponding specialized request to utilize for each of the specialized generative models. In some implementations, one or more of the corresponding specialized requests can be based on specialized content from processing another of the specialized requests utilizing another of the specialized generative models. For example a first specialized request can be specified for a first specialized generative model and a second specialized request can be specified for a second specialized generative model, and the second specialized request can be based on specialized content generated as a result of processing the first specialized request utilizing the first specialized generative model.

At block 360, the system determines, based on the initial content generated at block 358, a subset of the specialized generative models to utilize for processing the request. For example, those specialized generative models can be selected that are reflected in the initial content, as determined at block 358. Block 360 can include sub-block 360A and/or sub-block 360B.

At sub-block 360A, the system can determine a corresponding specialized request for each of the specialized generative models of the subset. For example, the system can determine the corresponding specialized requests based on them being reflected in the initial content, as determined at block 358.

At sub-block 360B, the system can determine an order and/or dependencies for generating specialized content utilizing the specialized generative models of the subset. For example, if none of the determined specialized requests, determined at block 360A, specify any specialized request that is dependent on specialized content generated based on another specialized request, at block 360B the system can determine to generate all specialized content in parallel. If, on the other hand, one or more of the determined specialized requests include a specialized request that is dependent on utilizing specialized content generated based on other specialized request(s), at block 360B the system can determine to generate the specialized content, based on such specialized requests, following generation of the specialized content that is based on the other specialized request(s).

At block 362, the system utilizes each of the specialized generative models of the subset determined at block 360 to generate corresponding specialized content from each of the specialized generative models of the subset. For example, the system can utilize a first specialized generative model of the subset to generate first specialized content that is based on a first specialized request, can utilize a second specialized generative model of the subset to generate second specialized content that is based on a second specialized request, and so forth.

At block 364, the system generates responsive content based on some or all of the specialized content generated from each of the specialized generative models of the subset at block 362. For example, the system can generate a comprehensive response prompt, that includes some or all of the specialized content generated from each of the specialized generative models, and process the comprehensive response prompt using a generative model, of the multiple generative models, to generate the responsive content.

At block 366, the system causes output, that is based on the responsive content generated at block 364, to be rendered at the client device.

Turning now to FIG. 4, a flowchart illustrating an example method 400 of determining and storing descriptive data for a specialized generative model is depicted. For convenience, the operations of the method 400 are described with reference to a system that performs the operations. This system may include various components of various computer systems, such as one or more components of the descriptive data system 140. Moreover, while operations of the method 400 are shown in a particular order, this is not meant to be limiting. One or more operations may be reordered, omitted or added.

At block 452, the system identifies historical interaction data for a specialized generative model. The historical interaction data can indicate one or more instances of interactions between a corresponding user and the specialized generative, such as instances where the specialized generative model was explicitly invoked by the corresponding user. The historical interaction data can include, for each instance, a corresponding request submitted using a corresponding client device and, optionally, a corresponding response, for the request, generated based at least in part on utilizing the specialized generative model. Block 452 can include sub-block 452A in which the system identifies user-specific historical interaction data that includes one or more instances of historical interactions that have been previously explicitly initiated by a particular user. In some implementations of block 452, only user-specific historical interaction data is identified via sub-block 452A. In those implementations, the descriptive data for the specialized generative model is user-specific and can be stored in association with the specialized generative model and in association with the user at block 460 (described below). Further, in those implementations, the user-specific descriptive data will be subsequently utilized (e.g., in method 300 of FIG. 3) for requests that are determined to be from the particular user.

At block 454, the system generates a descriptive data prompt that is based on the historical interaction data identified at block 452. For example, the descriptive data prompt can include a prompt of the form “given the following historical interaction and request pairs where a specialized generative model was explicitly invoked by the user, generate a description of the function of the specialized generative model: [historical interaction data]”. In some implementations, block 454 includes sub-block 454A in which the system generates the descriptive data prompt further based on creator-provided descriptive data for the specialized generative model. For example, the descriptive data prompt can include a prompt of the form “given the following historical interaction and request pairs where a specialized generative model was explicitly invoked by the user, and given [creator-provided description] of the specialized generative model, generate a description of any function(s) of the specialized generative model that are missing from the creator-provided description: [historical interaction data]”.

At block 456, the system causes the descriptive data prompt to be processed, using a generative model, to generate descriptive data output.

At block 458, the system determines descriptive data for the generative model based on the descriptive data output, for the descriptive data prompt, generated at block 456.

At block 460, the system stores the descriptive data determined at block 458 in association with the generative model. The descriptive data determined at block 458 can form all or part of descriptive data that is stored in association with the generative model. For example, at optional sub-block 469A, where the descriptive data is user-specific descriptive data, the descriptive data can be stored in association with the user and the generative model and, further, additional non-user specific descriptive data (e.g., creator-provided descriptive data) can also be stored in association with the generative model.

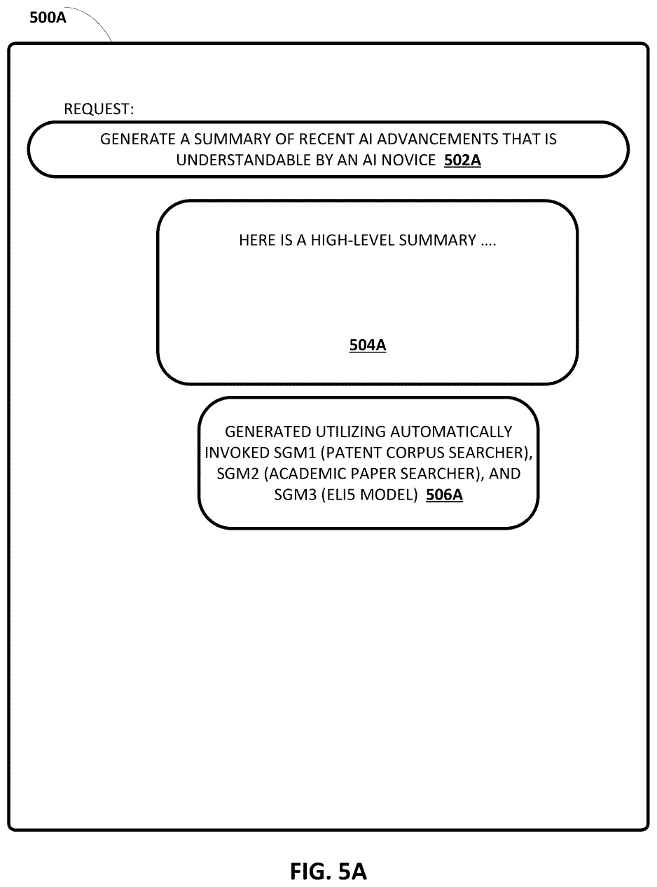

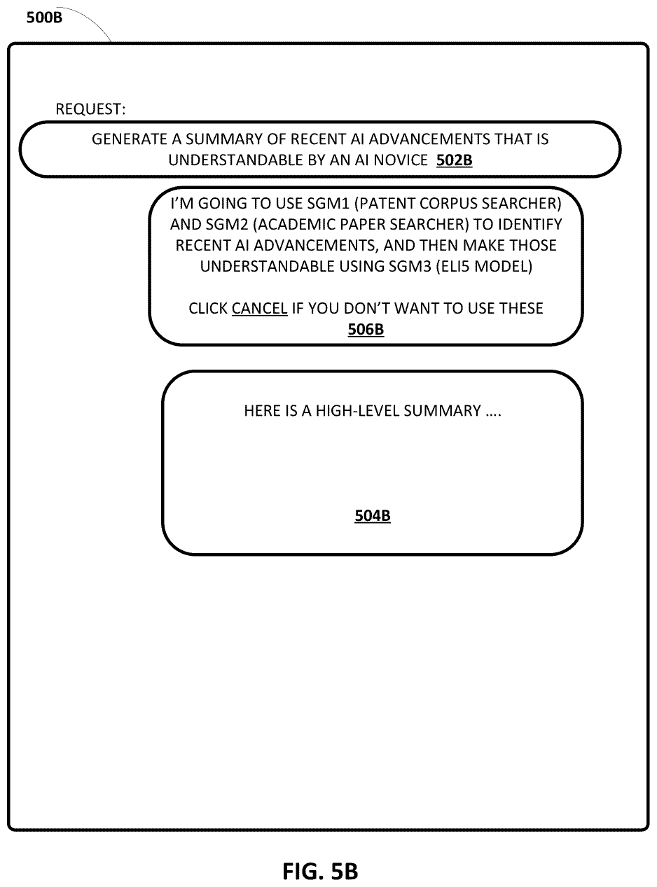

Turning now to FIG. 5A, an example of a graphical user interface 500A in which multiple specialized generative models can be invoked is depicted. The graphical user interface 500 can correspond to a user interface (UI) of a client device, such as a client device 110 of FIG. 1, that is utilized by a user. In FIG. 5A, the graphical user interface 500A includes a request field 502A in which a user has entered a request. In response to the user entering the request, the graphical user interface 500A displays output 504A that is based on multiple instances of specialized content generated by utilization of multiple respective specialized generative models. Further, the graphical user interface 500A also includes, following the output 504A, explanatory section 506A that is based on descriptive data for the specialized generative models that were utilized in generating the specialized content on which the output 504A is based.

Turning now to FIG. 5B, another example of a graphical user interface 500B in which multiple specialized generative models can be invoked is depicted. In FIG. 5B, the graphical user interface 500B includes a request field 502B in which a user has entered the same request as in FIG. 5A. In response to the user entering the request, the graphical user interface 500B first displays a user prompt 506B in which the specialized generative models that are slated to be utilized in processing the request are listed, with some descriptive data for each, and the user is provided with an option to cancel processing utilizing those specialized generative models. For example, the user can be provided with the option to select, within a time interval (e.g., 3 seconds, 5 seconds, or other interval) “cancel” through touch input or can speak “cancel” to cancel processing utilizing the specialized generative models. In the example of FIG. 5B, the user did not select “cancel”. Accordingly, the user provided affirmative user input through non-action and, as a result, the graphical user interface 500B displays output 504B, that is based on multiple instances of specialized content generated by utilization of multiple respective specialized generative models, following display of the user prompt 506B.

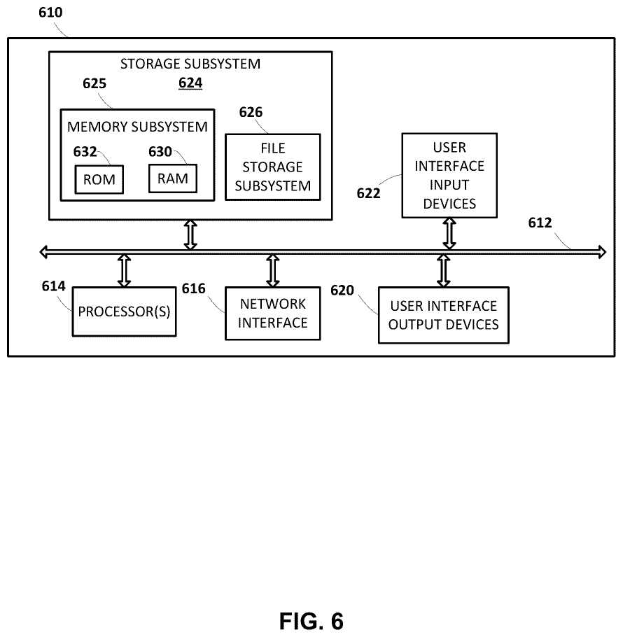

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided and includes receiving a request generated based on user interface input at a client device. The method further includes identifying, for each of multiple specialized generative models available for invocation in processing the request, corresponding descriptive data assigned to the specialized generative model and describing functionality of the specialized generative model. The method further includes generating a prompt including the request and the descriptive data assigned to each of the multiple specialized generative models. The method includes processing the prompt, using a generative model separate from the specialized generative models, to generate initial content. The method further includes determining, based on the initial content, a subset of the multiple specialized generative models to utilize in processing the request. The method further includes utilizing each of the specialized generative models, of the subset, in processing the request to generate corresponding specialized content from each of the specialized generative models. The method further includes generating, based on the corresponding specialized content, responsive content for the request. The method further includes causing output, based on the responsive content, to be rendered at the client device responsive to the request.

In some implementations, at least some of the descriptive data assigned to a given specialized generative model can be generated based on historical interaction data reflecting historical interactions of one or more users with the given specialized generative model. In some of those implementations, the one or more users can include a user that provided the user interface input. In some versions of those implementations, the one or more users can be restricted to the user that provided the user interface input, and the descriptive data assigned to the given specialized generative model can be utilized in generating the prompt based on determining that the user interface input is from the user. In some of those versions, the historical interaction data can include prior requests, by the user, from instances where the given specialized generative model was explicitly invoked based on user input of the user, and the prior requests can be utilized in generating the descriptive data for the given specialized generative model based on having been from the instances where the given specialized generative model was explicitly invoked. In some of those or other versions, generating the descriptive data can include processing a descriptive data prompt, including the prior requests, using the generative model or an additional generative model.

In some implementations, at least some of the descriptive data, assigned to a given specialized generative model of the multiple specialized generative models, can be generated based on prior requests from one or more users. Generating the descriptive data for the given specialized generative model can include processing a descriptive data prompt, including the prior requests, using the generative model or an additional generative model, and the prior requests can be utilized in generating the descriptive data for the given specialized generative model based on having been from past instances where the given specialized generative model was explicitly invoked by the one or more users. In some of those implementations, the descriptive data prompt can further include a creator-provided description generated by a creator of the given specialized generative model and describing at least one functionality of the given specialized generative model. In some versions of those implementations, the creator-provided description can describe one or more input types of expected input for the given specialized generative model and/or can describe one or more output types of expected output from the given specialized generative model.

In some implementations, the multiple specialized generative models that are available for invocation in processing the request, for which the corresponding descriptive data is identified, can be an initial subset of a superset of specialized generative models that are available for invocation in processing the request. The method can further include selecting the initial subset. In some of those implementations, selecting the initial subset can include: identifying, for each of the multiple specialized generative models that is a member of the superset, filtering data that is different from the descriptive data; and selecting, based on the filtering data, the initial subset of the superset of specialized generative models.

In some implementations, utilizing each of the specialized generative models, of the subset, in processing the request to generate the corresponding specialized content from each of the specialized generative models and generating the responsive content for the request can both occur responsive to the request and independent of any additional input, at the client device, after the client device received the user interface input.

In some implementations, the method can further include: causing a user prompt to be rendered, at the client device, specifying each of the specialized generative models of the subset, where utilizing each of the specialized generative models, of the subset, in processing the request to generate the corresponding specialized content from each of the specialized generative models can be performed responsive to affirmative user input that is received in response to the user prompt.

In some implementations, the initial content can describe the subset of the multiple specialized generative models and can describe, for each of the multiple generative models of the subset, a corresponding sub-request to process utilizing the generative model. Utilizing each of the specialized generative models, of the subset, in processing the request to generate the corresponding specialized content from each of the specialized generative models can include: processing, using a given specialized generative model of the multiple generative models of the subset, the corresponding sub-request that is described in the initial content as being for the given specialized generative model, to generate corresponding specialized content from the given specialized generative model. In some of those implementations, generating, based on the corresponding specialized content, the responsive content for the request can include: generating a comprehensive response prompt including the corresponding specialized content for each of the specialized generative models of the subset; and processing the comprehensive response prompt using the generative model, or an additional generative model, to generate the responsive content for the request. In some versions of those implementations, the corresponding sub-request, described for an additional specialized generative model of the multiple specialized generative models, can be dependent on the corresponding specialized content that is generated using the given specialized generative model. Utilizing the additional specialized generative model in processing the request to generate corresponding specialized content from the additional specialized generative model can include, subsequent to utilizing the given specialized generative model in processing the corresponding sub-request to generate the corresponding specialized content from the given specialized generative model, generating an additional prompt that is based on the sub-request and the corresponding specialized content from the given specialized generative model; and processing the additional prompt using the additional specialized generative model to generate the corresponding specialized content from the additional specialized generative model.

In some implementations, the specialized generative models of the subset can include: a first specialized generative model including a given generative model and certain instructions that are to be utilized in conjunction with prompts that are processed utilizing the given generative model; and a second specialized generative model including the given generative model and alternative certain instructions that are to be utilized in conjunction with prompts that are processed utilizing the given generative model.

In some implementations, the specialized generative models of the subset can include: a first specialized generative model including a given generative model and a given corpus that is utilized to retrieve content for including in prompts that are to be processed utilizing the given generative model; and a second specialized generative model including the given generative model and an additional corpus that is utilized to retrieve content for including in prompts that are to be processed utilizing the given generative model.

In some implementations, the specialized generative models of the subset can include: a first specialized generative model including a given generative model, certain instructions that are to be utilized in conjunction with prompts that are processed utilizing the given generative model, and a given corpus that is utilized to retrieve content for including in prompts that are to be processed utilizing the given generative model; and a second specialized generative model including the given generative model, alternative certain instructions that are to be utilized in conjunction with prompts that are processed utilizing the given generative model, and an additional corpus that is utilized to retrieve content for including in prompts that are to be processed utilizing the given generative model.

In some implementations, the specialized generative models of the subset can include: a first specialized generative model that is a first fine-tuned version of a given generative model; and a second generative model that is a second fine-tuned version of the given generative model.

What is claimed is:

1. A method implemented by one or more processors, the method comprising:
receiving a request that is generated based on user interface input at a client device;
identifying, for each of multiple specialized generative models that are available for invocation in processing the request, corresponding descriptive data that is assigned to the specialized generative model and that describes functionality of the specialized generative model;
generating a prompt that includes the request and the descriptive data assigned to each of the multiple specialized generative models;
processing the prompt, using a generative model that is separate from the specialized generative models, to generate initial content; determining, based on the initial content, a subset of the multiple specialized generative models to utilize in processing the request;
in response to determining the subset of the multiple specialized generative models to utilize in processing the request:
utilizing each of the specialized generative models, of the subset, in processing the request to generate corresponding specialized content from each of the specialized generative models; and
generating, based on the corresponding specialized content, responsive content for the request; and
causing output, that is based on the responsive content, to be rendered at the client device responsive to the request.

2. The method of claim 1, wherein at least some of the descriptive data assigned to a given specialized generative model of the specialized generative models is generated based on historical interaction data that reflects historical interactions of one or more users with the given specialized generative model.

3. The method of claim 2, wherein the one or more users include a user that provided the user interface input.

4. The method of claim 3, wherein the one or more users are restricted to the user that provided the user interface input and wherein the descriptive data assigned to the given specialized generative model is utilized in generating the prompt based on determining that the user interface input is from the user.

5. The method of claim 4, wherein the historical interaction data includes prior requests, by the user, from instances where the given specialized generative model was explicitly invoked based on user input of the user, and wherein the prior requests are utilized in generating the descriptive data for the given specialized generative model based on having been from the instances where the given specialized generative model was explicitly invoked.

6. The method of claim 5, wherein generating the descriptive data comprises processing a descriptive data prompt, that includes the prior requests, using the generative model or an additional generative model.

7. The method of claim 1,
wherein at least some of the descriptive data, assigned to a given specialized generative model of the multiple specialized generative models, is generated based on prior requests from one or more users,
wherein generating the descriptive data for the given specialized generative model comprises processing a descriptive data prompt, that includes the prior requests, using the generative model or an additional generative model, and
wherein the prior requests are utilized in generating the descriptive data for the given specialized generative model based on having been from past instances where the given specialized generative model was explicitly invoked by the one or more users.

8. The method of claim 7, wherein the descriptive data prompt further includes a creator provided description that is generated by a creator of the given specialized generative model and that describes at least one functionality of the given specialized generative model.

9. The method of claim 8, wherein the creator provided description describes one or more input types of expected input for the given specialized generative model and/or describes one or more output types of expected output from the given specialized generative model.

10. The method of claim 1, wherein the multiple specialized generative models that are available for invocation in processing the request, for which the corresponding descriptive data is identified, are an initial subset of a superset of specialized generative models that are available for invocation in processing the request and further comprising selecting the initial subset.

11. The method of claim 10, wherein selecting the initial subset comprises:
identifying, for each of the multiple specialized generative models that is a member of the superset, filtering data that is different from the descriptive data; and selecting, based on the filtering data, the initial subset of the superset of specialized generative models.

12. The method of claim 1, wherein utilizing each of the specialized generative models, of the subset, in processing the request to generate the corresponding specialized content from each of the specialized generative models and wherein generating the responsive content for the request both occur responsive to the request and independent of any additional input, at the client device, after the client device received the user interface input.

13. The method of claim 1, further comprising:
causing a user prompt to be rendered, at the client device, that specifies each of the specialized generative models of the subset;
wherein utilizing each of the specialized generative models, of the subset, in processing the request to generate the corresponding specialized content from each of the specialized generative models is performed responsive to affirmative user input that is received in response to the user prompt.

14. The method of claim 1,
wherein the initial content describes the subset of the multiple specialized generative models and describes, for each of the multiple generative models of the subset, a corresponding sub-request to process utilizing the generative model, and
wherein utilizing each of the specialized generative models, of the subset, in processing the request to generate the corresponding specialized content from each of the specialized generative models comprises:
processing, using a given specialized generative model of the multiple generative models of the subset, the corresponding sub-request that is described in the initial content as being for the given specialized generative model, to generate corresponding specialized content from the given specialized generative model.

15. The method of claim 14, wherein generating, based on the corresponding specialized content, the responsive content for the request comprises:
generating a comprehensive response prompt that includes the corresponding specialized content for each of the specialized generative models of the subset; and processing the comprehensive response prompt using the generative model, or an additional generative model, to generate the responsive content for the request.

16. The method of claim 14,
wherein the corresponding sub-request, described for an additional specialized generative model of the multiple specialized generative models, is dependent on the corresponding specialized content that is generated using the given specialized generative model, and
wherein utilizing the additional specialized generative model in processing the request to generate corresponding specialized content from the additional specialized generative model comprises:
subsequent to utilizing the given specialized generative model in processing the corresponding sub-request to generate the corresponding specialized content from the given specialized generative model: generating an additional prompt that is based on the sub-request and the corresponding specialized content from the given specialized generative model; and
processing the additional prompt using the additional specialized generative model to generate the corresponding specialized content from the additional specialized generative model.

17. The method of claim 1, wherein the specialized generative models of the subset include:
a first specialized generative model that includes a given generative model and certain instructions that are to be utilized in conjunction with prompts that are processed utilizing the given generative model; and
a second specialized generative model that includes the given generative model and alternative certain instructions that are to be utilized in conjunction with prompts that are processed utilizing the given generative model.

18. The method of claim 1, wherein the specialized generative models of the subset include:
a first specialized generative model that includes a given generative model and a given corpus that is utilized to retrieve content for including in prompts that are to be processed utilizing the given generative model; and
a second specialized generative model that includes the given generative model and an additional corpus that is utilized to retrieve content for including in prompts that are to be processed utilizing the given generative model.

19. The method of claim 1, wherein the specialized generative models of the subset include:
a first specialized generative model that includes a given generative model, certain instructions that are to be utilized in conjunction with prompts that are processed utilizing the given generative model, and a given corpus that is utilized to retrieve content for including in prompts that are to be processed utilizing the given generative model; and
a second specialized generative model that includes the given generative model, alternative certain instructions that are to be utilized in conjunction with prompts that are processed utilizing the given generative model, and an additional corpus that is utilized to retrieve content for including in prompts that are to be processed utilizing the given generative model.

20. The method of claim 1, wherein the specialized generative models of the subset include:
a first specialized generative model that is a first fine-tuned version of a given generative model; and
a second generative model that is a second fine-tuned version of the given generative model.
